(19) United States
(12) Patent Application Publication
(10) Pub. No.: US 2022/0340145 A1
(43) Pub. Date: Oct. 27, 2022

(54) AUTOMATIC RECOMMENDATION OF CONTROL IN A SIMULTANEOUS MIX MODE VEHICLE

(71) Applicant: HERE Global B.V., Eindhoven (NL)

(72) Inventors: Leon Stenneth, Chicago, IL (US); Jerome Beaurepaire, Berlin (DE); Jeremy Michael Young, Chicago, IL (US)

(21) Appl. No.: 17/236,195

(22) Filed: Apr. 21, 2021

(51) Int. Cl. B60W 40/09; G06N 20/00; B60W 60/00; B60W 10/20; B60W 10/18; B60W 10/30; B60Q 5/00; B60Q 1/34; G01C 21/34; B60W 50/14; G05D 1/00

(52) U.S. Cl. CPC B60W 40/09; G06N 20/00; B60W 60/001; B60W 10/20; B60W 10/18; B60W 10/30; B60Q 5/00; B60Q 1/34; G01C 21/3407; B60W 50/14; G05D 1/0011; B60W 2050/146; B60W 2556/10

(57) ABSTRACT

Systems and methods for mix mode driving including the selection of driving operations, generation of recommendations for the assignment of the driving operations, and application of the assignment of driving operations to specific operators based on a number of factors.

### FIELD

The following disclosure relates to simultaneous mix mode driving, including recommending control to multiple occupants of a vehicle.

### BACKGROUND

Drive by wire, by-wire, Steer-by-wire, Fly-by-wire or x-by-wire technology in the automotive industry is the use of electrical or electro-mechanical systems for performing vehicle functions traditionally achieved by mechanical linkages. These technologies have allowed the control of a vehicle to be physically separate from the input mechanisms. An operator no longer has to be present in a particular location, for example, the driver's seat to control the vehicle. In addition, certain actions and features have been automated so that they may be controlled automatically, remotely, or by different occupants. This allows control of the vehicle to be performed piecemeal by two or more different occupants and/or automatically by self-driving technologies. In one example, a first operator controls one feature and a second operator controls a second feature. In another example, one of the features are controlled by self-driving technology while occupants perform other operations. A challenge is identifying and assigning operations so that the vehicle performs both safely and efficiently while under the control of multiple operators.

### SUMMARY

In one embodiment, a system for simultaneous mix mode driving including a simultaneous mix mode controller, a mapping system, a geographic database, and one or more sensors. A simultaneous mix mode vehicle is configured for two or more different operators to control a plurality of driving features. The mapping system is configured to store profile data for the two or more different operators. The geographic database is configured to store mapping data. The one or more sensors are configured to acquire sensor data for the simultaneous mix mode vehicle. The simultaneous mix mode controller is configured to generate recommendations for which operator to control each of the driving features as a function of the profile data, mapping data, and sensor data, the simultaneous mix mode controller further configured to provide access to respective interfaces for the recommended operators to perform the recommended operations.

In another embodiment, a method for mix mode driving, the method comprising: identifying a plurality of segments for a route for a vehicle to traverse from a starting point to a destination; determining a plurality of driving operations for each of the plurality of segments; accessing profiles for at least two or more operators of the vehicle that are capable of performing at least one driving operation of the plurality of driving operations; generating recommendations for which operator to perform each of the plurality of driving operations for each of the plurality of segments based on at least the profiles of the at least two or more operator; and providing the recommendations to the at least two or more operators.

In another embodiment, an apparatus for mixed mode driving, the apparatus comprising a memory configured to store profile data for at least two occupants of a simultaneous mix mode vehicle and a controller configured to determine at least one recommended driving operation included in a list of possible operations based on the profile data, the at least one recommended driving operation including a first driving operation designated to a first occupant and a second driving operation designated to a second occupant.

### BRIEF DESCRIPTIONS OF THE DRAWINGS

Exemplary embodiments of the present invention are described herein with reference to the following drawings.

FIG. 1 depicts an example system for mixed mode driving.

FIG. 2 depicts an example simultaneous mix mode vehicle according to an embodiment.

FIG. 3 depicts an example simultaneous mix mode controller of FIG. 2 according to an embodiment.

FIG. 4 depicts an example server of FIG. 1.

FIG. 5 depicts an example mobile device of FIG. 1.

FIG. 6 depicts an example flowchart for a method of generating recommendations for mix mode driving according to an embodiment.

FIG. 7 depicts an example map of a geographic region.

FIG. 8 depicts an example geographic database of the system of FIG. 1.

FIG. 9 depicts example structure of segments and nodes in the geographic database.

FIG. 10 depicts example autonomous vehicles.

### DETAILED DESCRIPTION

A simultaneous mix mode vehicle is a vehicle that two or more operators control at the same time. For example, in one driving session, a first occupant operates the steering while a second occupant operates the brake. These and other driving operations may be assigned to occupants of the vehicle, an autonomous driving system, or a remote operator. The following embodiments include an apparatus and method for the generation of recommendations for the assignment of the driving operations and application of the assignment of driving operations to specific operators based on a number of factors.

The automatic recommendation of control for a simultaneous mix mode vehicle (SMMV) includes automatically recommending a set of operations to be performed by each operator, for example by splitting the responsibilities or controls between two different occupants of the vehicle. The system recommends specific controls to specific operators depending on several factors. The factors include, among other factors, a historical driving record of each operator (for example a history of operating a specific vehicle control successfully in the past). For this factor, historically operated controls are saved to a profile that may be accessed and updated in real time. Other factors include seating position (for example, an operator sitting on the right of the SMMV may be recommended to control the right turn signal), reaction times (for example, the operators with the fastest reaction times may be recommended to perform critical functions), a location of the vehicle, for example, variable control at specific locations (for example based on geofencing, dynamic risks attributes of an area, population density, specific functional class roads, etc.), expertise of each operator (for example if one operator is an expert braker, etc), fuel efficiency (for example one operator may be better at fuel efficiency through more efficient braking, for example, in a certain type of area), familiarity with an area based on historical information about an operator, or learning curves of the operators. The recommendations may also be contextually dependent (for example the way an operator is seated, mood of an operator, tiredness/drowsiness, availability, success rates with some controls, weather, demographics). The system may also be configured to recommend when to start/end the control or switching to other user(s), a duration, etc. The recommendations are provided to the possible operators. The operators may be occupants of the vehicle, software/hardware (e.g., self-driving software), or remotely located operators. The recommendations may then be implemented by the SMMV, granting access to each of the respective interfaces or controls that are used to perform specific actions/driving operations for the SMMV at respective times.

In one example, the driving operations includes steering, braking, acceleration, horn, left turn signal, and right turn signal. Other driving operations are possible depending on the type and features of a vehicle. The list of possible driving operations may be provided in a user interface (UI), that may be a vehicle-integrated navigation display or on a mobile device (e.g., phone) that is connected to the vehicle or otherwise associated with the vehicle. Occupants may operate the UI to select one or more driving operations to be performed by respective operators. An operator may select the driving operation that they desire to perform. For one example, an operator may select steering and left turn signal after receiving recommendations. This selection causes both the steering and left turn signal to be under the operator's control. The other operations such as braking, acceleration, horn and right turn signal may be assigned or granted to another operator, for example a second occupant of the vehicle, a remote operator or software/hardware configured to perform the respective operation.

In an embodiment, the operators are occupants of a SMMV. The controls of the SMMV may be physical controls, for example pedals, switches, knobs, a steering wheel, etc. or may be implemented using a user interface provided by a device such as a smartphone, touchscreen, or tablet etc. Two or more of the occupants may be recommended by the SMMV to each perform one or more tasks. In an example, one occupant may be assigned steering and the turn signals while another may be assigned braking and acceleration. Another occupant may be assigned the operation of the horn. Not all of the occupants may be assigned a task or recommended to perform an operation based on the factors described below.

In an embodiment, the operators may be remotely located. In this situation, while not located in the SMMV, the remote operator may have access to external sensors in addition to the vehicle's ones. The remote operator may control one or more options by communicating wirelessly with the SMMV and controls therein. The remote operator may be a human or may be autonomous.

In an embodiment, the operators (remote or onboard) may include one or more automated functions. Co-pending application Ser. No. 17/119,973 filed Dec. 23, 2020, hereby incorporated by reference in its entirety, describes a simultaneous mix mode vehicle including a combination of one or more automated driving operations and one or more manual driving operations. Many driver assistance features aid drivers in driving and parking a vehicle. Various subsets of these features may sometimes be referred to as “automated driving,” “highly assisted driving,” “advanced driving assistance systems,” or “autonomous driving.” Driver assistance features may have different levels of sophistication, ranging from simple warning to complex systems that may drive a car without user input. The driver assistance features may be enabled by an engine control management (ECM) system on a vehicle. The driver assistance features may rely on different sensor technologies and high definition (HD) MAP or dynamic backend content, including traffic information services, to aid the in-vehicle ECM system for the right decision strategy as how to drive along the road network.

The driving operations may also be selected, recommended, and/or displayed according to hierarchies or levels. That is, rather than recommending and selecting individual driving operations, set of driving operations may be recommended or selected.

The following embodiments also relate to several technological fields including but not limited to navigation, autonomous driving, assisted driving, traffic applications, and other location-based systems. The following embodiments achieve advantages in each of these technologies because improved data for driving or navigation improves the accuracy of each of these technologies by allowing fine-tuned selections of the control of driving operations in different situations. In each of the technologies of navigation, autonomous driving, assisted driving, traffic applications, and other location-based systems, the number of users that can be adequately served is increased. In addition, users of navigation, autonomous driving, assisted driving, traffic applications, and other location-based systems are more willing to adopt these systems given the technological advances in accuracy.

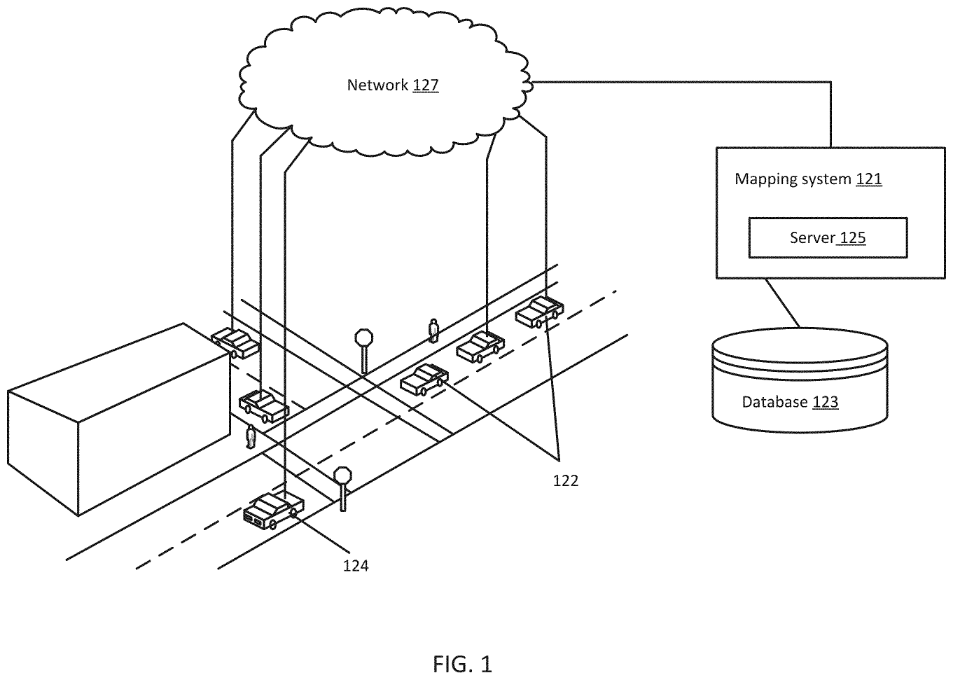

FIG. 1 illustrates an example system for automatic recommendations for a simultaneous mix mode vehicle. The system includes at least an SMMV 124, one or more devices 122, a network 127, and a mapping system 121. The mapping system 121 may include a database 123 (also referred to as a geographic database 123 or map database) and at least one server 125. Additional, different, or fewer components may be included in the system. The following embodiments may be entirely or substantially performed at the server 125, or the following embodiments may be entirely or substantially performed at the SMMV 124. In some examples, some aspects are performed at the SMMV 124 and other aspects are performed at the server 125.

In an embodiment, the one or more devices 122 collect data about the environment and area in and around the SMMV 124 using one or more sensors. The mapping system 121 and geographic database 123 maintain and provide mapping data relating to the operation of the SMMV 124. The server 125 acquires and stores profile data related to potential operators of the SMMV 124. The SMMV 124 uses the profile data, environmental data, and mapping data as inputs for calculating or analyzing one or more factors with which the SMMV 124 uses to generate recommendations for assigning different operations of the SMMV 124 to different operators in order to provide efficient and safe operation of the SMMV 124.

The SMMV 124 is configured to be controlled by two of more different operators using two or more different interfaces. The two or more operators may include occupants (also referred to as passengers or drivers) of the SMMV 124. The two or more operators may also include remote operators (either human or computer controlled). The two or more operators may include one or more computerized or automated systems that are configured to perform certain operations. For example, an assisted or fully automated driving system may be incorporated into the device 122 and thus the SMMV 124. Alternatively, an automated driving device may be included in the vehicle. The automated driving device may include a memory, a processor, and systems to communicate with a device 122. The interfaces may be configured to perform one or more operations, for example steering, braking, acceleration, horn, left turn signal, and right turn signal among other operations. The automated driving device may respond to geographic data received from the geographic database 123 and the server 125. The automated driving device may take route instructions based on a road segment and node information provided to the navigation device 122. A SMMV 124 may be configured to receive routing instructions from a mapping system 121 and automatically perform an action in furtherance of the instructions. The SMMV 124 may access profile data about potential operators, analyze the profile data, and use the profile data and other data to calculate or resolve factors that assist the SMMV 124 in identifying and recommending operators for specific operators. In addition, the ability of the SMMV 124 to understand its precise positioning, plan beyond sensor visibility, possess contextual awareness of the environment, and local knowledge of the road rules may be used in selecting and assigning driving operations to different operators.

The SMMV 124 may include one or more sensors that monitor the interior and exterior of the SMMV 124. The one or more sensors may be configured to identify context for making a recommendation, for example by monitoring the status of the occupants of the SMMV 124. The one or more sensors may also communicate or provide data to the devices 122, for example, a device embedded in the SMMV 124. The devices 122 may include a probe or position circuitry such as one or more processors or circuits for generating probe data. The probe points are based on sequences of sensor measurements of the probe devices collected in the geographic region. The probe data may be generated by receiving global navigation satellite system (GNSS) signals and comparing the GNSS signals to a clock to determine the absolute or relative position of the mobile device 122. The probe data may be generated by receiving radio signals or wireless signals (e.g., cellular signals, the family of protocols known as WIFI or IEEE 802.11, the family of protocols known as Bluetooth, or another protocol) and comparing the signals to a pre-stored pattern of signals (e.g., radio map). The mobile device 122 may act as the probe for determining the position or the mobile device 122 and the probe may be separate devices.

The probe data may include a geographic location such as a longitude value and a latitude value. In addition, the probe data may include a height or altitude. The probe data may be collected over time and include timestamps. In some examples, the probe data is collected at a predetermined time interval (e.g., every second, every 100 milliseconds, or another interval). In this case, there are additional fields like speed and heading based on the movement (i.e., the probe provides location information when the probe moves a threshold distance). The predetermined time interval for generating the probe data may be specified by an application or by the user. The interval for providing the probe data from the mobile device 122 to the server 125 may be the same or different than the interval for collecting the probe data. The interval may be specified by an application or by the user.

The device 122 may also use passive sensors, such as vision-based techniques with cameras or other imaging sensors to understand its position and monitor the interior and surroundings of the SMMV 124. The device 122 may use a vision-based technique to calculate an odometry from feature points of an acquired image and positioning in real-time. The device 122 identifies lane markings and GPS and inertial measurement units (IMU) provide the positioning. The device 122 may include one or more distance data detection devices or sensors, such as a LiDAR or RADAR device. Radar sends out radio waves that detect objects and gauge their distance and speed in relation to the vehicle in real time. Both short- and long-range radar sensors may be deployed all around the car and each one has their different functions. While short range (24 GHz) radar applications enable blind spot monitoring, for example lane-keeping assistance, and parking aids, the roles of the long range (77 GHz) radar sensors include automatic distance control and brake assistance. Unlike camera sensors, radar systems typically have no trouble when identifying objects during fog or rain. The device 122 may also be equipped with LiDAR. LiDAR sensors work similar to radar systems, with the difference being that LiDAR uses lasers instead of radio waves. Apart from measuring the distances to various objects on the road, the device 122 may use LiDAR to create 3D images of the detected objects and mapping the surroundings. The device 122 may use LiDAR to create a full 360-degree map around the vehicle rather than relying on a narrow field of view.

The device 122 may also use a map-matching method provided by a precise high-definition (HD) map. An HD map, stored in or with the geographic database 123 or in the devices 122 is used to allow a device 122 to identify precisely where it is with respect to the road (or the world) far beyond what the Global Positioning System (GPS) can do, and without inherent GPS errors. The HD map allows the device 122 to plan precisely where the device 122 may go, and to accurately execute the plan because the device 122 is following the map. The HD map provides positioning and data with decimeter or even centimeter precision.

The SMMV 124 is configured to communicate with the devices 122, mapping system 121, and geographic database 123 to understand its position and acquire data for resolving factors for determining which operators are to be recommended for certain operations. The factors may include, for example, seating position, historically controlled operations, reaction times, vehicle or occupant context, location context, expertise, sequence or timing, fuel efficiency, familiarity, or learning curve among others. These factors may be combined in a recommender system algorithm such as a collaborative filtering algorithm. The algorithm takes the available factors into consideration and makes one or more recommendations. The data for analyzing or determining the factors may be derived from sensors embedded in or in communication with the device 122, SMMV 124, or from outside sources such as the server 125, mapping system 121, or other vehicles or data sources. As an example, a high-definition map and geographic database 123 maintained and updated at the mapping system 121 may be used to provide information for several of the factors. The high-definition map and the geographic database 123 are maintained and updated by the mapping system 121. The mapping system 121 may include multiple servers, workstations, databases, and other machines connected together and maintained by a map developer. The mapping system 121 may be configured to acquire and process data relating to roadway or vehicle conditions. For example, the mapping system 121 may receive and input data such as vehicle data, user data, weather data, road condition data, road works data, traffic feeds, etc. The data may be historical, real-time, or predictive.

The server 125 may be a host for a website or web service such as a mapping service and/or a navigation service. The mapping service may provide standard maps or HD maps generated from the geographic data of the database 123, and the navigation service may generate routing or other directions from the geographic data of the database 123. The mapping service may also provide information generated from attribute data included in the database 123. The server 125 may also provide historical, future, recent or current traffic conditions for the links, segments, paths, or routes using historical, recent, or real time collected data. The server 125 is configured to communicate with the devices 122 through the network 127. The server 125 is configured to receive a request from a device 122 for a route or maneuver instructions and generate one or more potential routes or instructions using data stored in the geographic database 123. The server 125 is also configured to receive a request from a SMMV 124 for factor data. The factor data may include mapping data or profile data for a potential operator. The factor data may include, for example, historical data related to past operations by a specific operator, that related to, for example, fuel efficiency or familiarity of the specific operator with a certain area.

To communicate with the devices 122, the SMMV 124, systems or services, the server 125 is connected to the network 127. The server 125 may receive or transmit data through the network 127. The server 125 may also transmit paths, routes, or risk data through the network 127. The server 125 may also be connected to an OEM cloud that may be used to provide mapping services to vehicles via the OEM cloud or directly by the mapping system 121 through the network 127. The network 127 may include wired networks, wireless networks, or combinations thereof. The wireless network may be a cellular telephone network, LTE (Long-Term Evolution), 4G LTE, a wireless local area network, such as an 802.11, 802.16, 802.20, WiMAX (Worldwide Interoperability for Microwave Access) network, DSRC (otherwise known as WAVE, ITS-G5, or 802.11p and future generations thereof), a 5G wireless network, or wireless short-range network such as Zigbee, Bluetooth Low Energy, Z-Wave, RFID and NFC. Further, the network 127 may be a public network, such as the Internet, a private network, such as an intranet, or combinations thereof, and may utilize a variety of networking protocols now available or later developed including, but not limited to transmission control protocol/internet protocol (TCP/IP) based networking protocols. The devices 122 and SMMV 124 may use Vehicle-to-vehicle (V2V) communication to wirelessly exchange information about their speed, location, heading, and roadway conditions with other vehicles, devices 122, or the mapping system 121. The devices 122 may use V2V communication to broadcast and receive omni-directional messages creating a 360-degree “awareness” of other vehicles in proximity of the vehicle. Vehicles equipped with appropriate software may use the messages from surrounding vehicles to determine potential threats or obstacles as the threats develop. The devices 122 may use a V2V communication system such as a Vehicular ad-hoc Network (VANET).

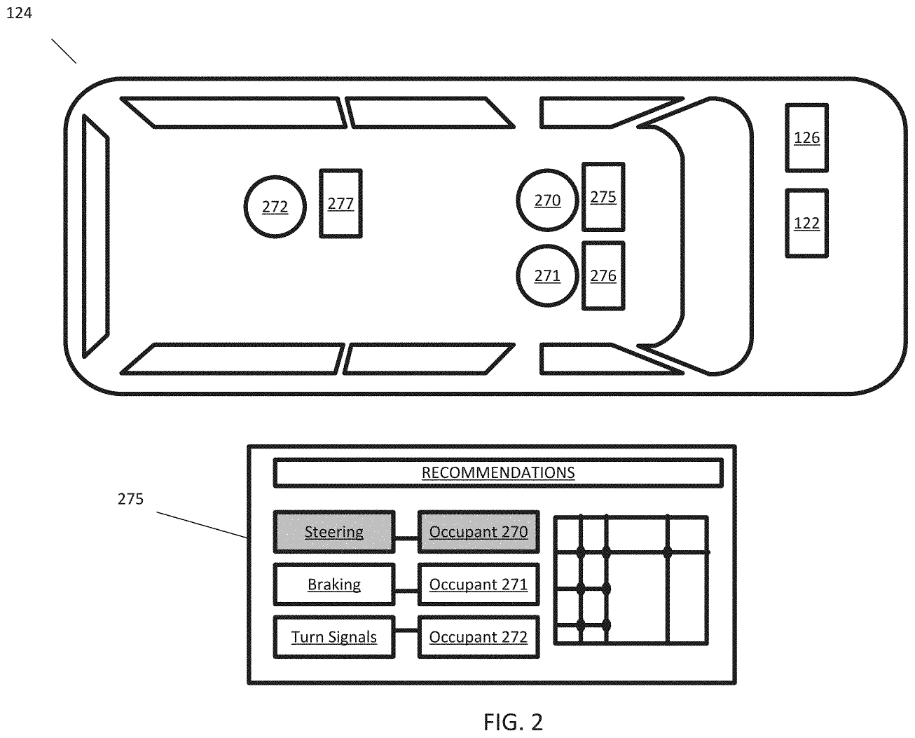

FIG. 2 depicts an example SMMV 124 of the system of FIG. 1. The SMMV 124 includes at least two occupants (here three occupants 272, 270, and 271), at least two interfaces (here three interfaces 275, 276, and 277), a simultaneous mix mode controller 126 and a device 122. FIG. 2 also depicts an example of an interface 275 that displays the recommendations generated by the simultaneous mix mode controller 126. In FIG. 2, the system makes a recommendation that three operations (Steering, braking, and turn signals) are controlled by three different occupants 270, 271, 272. The system recommends that Occupant 270 control the steering (e.g., due to Occupant 270 being an expert steerer), the system recommends that Occupant 271 controls the acceleration (e.g., due to Occupant 271's low reaction time) and Occupant 272 should control the signals (e.g., Occupant 272 is sitting in the back of the vehicle and can clearly see potential hazards to the left and right side of the vehicle). The device 122 is configured to collect data about the occupants 270, 271, 272, the environment around the vehicle using one or more sensors. The user interfaces 275, 276, 277 are configured to display the recommendations to the Occupants 270, 271, 272. One or more of the recommendations may be highlighted or otherwise marked (here shaded) to emphasis to a specific operator the control that is being assigned or recommended. The user interfaces 275, 276, 277 may also be configured to provide control of the respective features of the SMMV 124 to the occupants 270, 271, 272 after the recommendations have been accepted or assigned. The simultaneous mix mode controller 126 is configured to analyze data (factor data) from the device 122, the server 125, the mapping system 121, and the geographic database 123 to generate the recommendations.

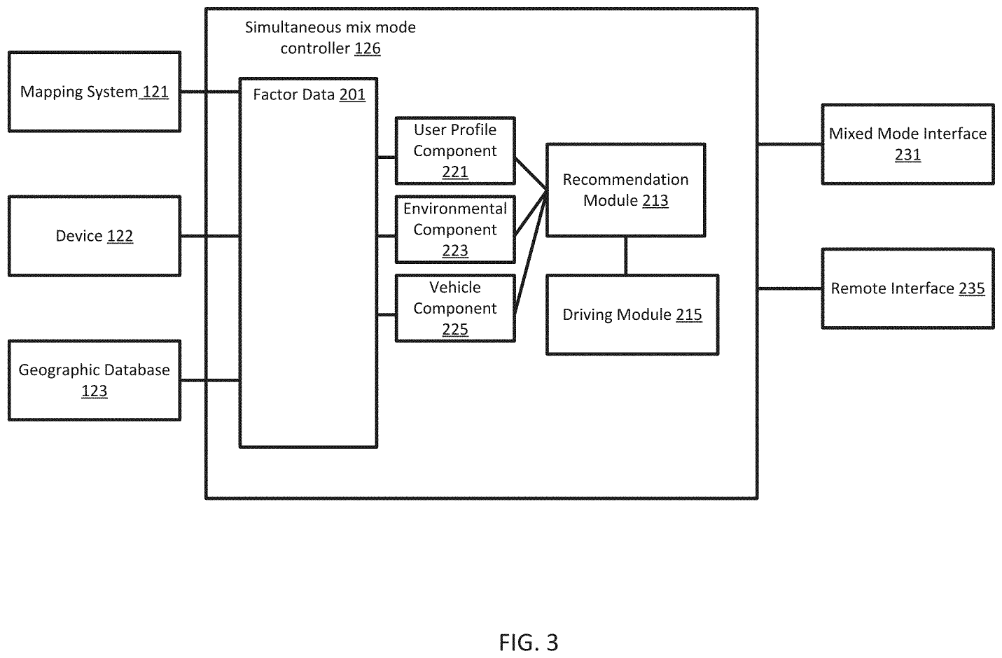

FIG. 3 illustrates an embodiment of a simultaneous mix mode controller 126 of the system of FIG. 3. The simultaneous mix mode controller 126 may be implemented at the server 125, mapping system 121, or, as depicted in FIG. 2, at the SMMV 124. The simultaneous mix mode controller 126 may be integrated or included with the mobile device 122. The simultaneous mix mode controller 126 may be implemented in software or hardware. The simultaneous mix mode controller 126 may be implemented in the cloud or run as SAAS. The simultaneous mix mode controller 126 may include one or more components or modules that acquire or store factor data that is used to generate recommendations. The simultaneous mix mode controller 126 may include among others, a user profile component 221, an environmental component 223, and a vehicle component 225. Other components may be used, combined, or removed. The components are configured to analyze the factor data 201 and provide values or analysis to the simultaneous mix mode controller 126. The simultaneous mix mode controller 126 also includes a recommendation module 213 configured to generate recommendations based on the factor data and a driving module 215 configured to implement the recommendations and provide autonomous driving support for the SMMV 124 for simultaneous mixed mode operation. The simultaneous mix mode controller 126 may also be connected to one or more mixed mode interfaces 231 (depicted as user interfaces 275, 276, 277 in FIG. 2) or one or more remote interfaces 235 that provide remote control of the SMMV 124. The term “simultaneous mixed mode” includes driving trips where two or more operations of the vehicle are split between different operators. The different operators may include occupants of the vehicle, remote operators, and/or software/hardware that is configured to perform the one or more operations. Additional, different, or fewer components may be included, for example, one or more user interfaces by which recommendations may be displayed and control may be provided to different occupants.

In an embodiment, the simultaneous mix mode controller 126 is configured to generate recommendations for certain operations to be performed by different operators based on one or more factors. The different operators may include multiple occupants of the SMMV 124, autonomous systems, or remote operators. The factors that are used in generating the recommendations include, among others, seating position of potential operators, historically controlled operations, reaction times, vehicle or occupant context, location context, expertise, sequence or timing, fuel efficiency, familiarity, or learning curve among others. Factor data 201 is acquired from the mapping system 121, devices 122, and the geographic database 123. The factor data 201 is stored and/or analyzed by one or more components 222, 223, 225. For example, the user profile component 221, environmental component 223, and vehicle component 225 collect and store data for each of these factors and provide values or information from which the recommendation module 213 generates its recommendations. In an example, the user profile component 221 analyzes information about the driving skills for the occupants of the SMMV 124. The environmental component 223 analyzes information about the roadway (for example accessed from the geographic database 123) including current roadway conditions. The vehicle component 225 analyzes data about the SMMV 124 including the abilities of the SMMV 124 and historical operative data. The recommendation module 213 inputs the analysis of the factor data 201 and outputs one or more recommendations for operation of the SMMV 124 by each potential operator. The driving module 215 is configured to implement the recommendations by providing access to respective interfaces 231, 235 for respective control systems for operation of the SMMV 124 or to provide automatic control.

The simultaneous mix mode controller 126 may include a memory or datastore that includes factor data 201. The factor data 201 includes one or more characteristics of the users and/or entities involved with a simultaneous mixed mode driving trip, positioning and environmental data about involved with the simultaneous mixed mode driving trip, and vehicle data for the simultaneous mixed mode driving trip. The factor data 201 may include data relating to seating position, historically controlled operations, reaction times, vehicle or occupant context, location context, expertise, sequence or timing, fuel efficiency, familiarity, or learning curve among others. The factor data 201 may be real-time, historic, or predictive. The factor data may be stored together or may be acquired and stored in different datastores.

The user profile component 221 stores and analyzes the factor data 201 associated with each of the operators. The factor data 201 may be accessed from memory or be requested from an external source. The user profile component 221 may filter profile data and identify one or more characteristics or properties described below for defining the list of driving operations that will be recommended according to the factor data 201 and other factors relating to the potential operators and the simultaneous mixed mode driving trip. Profiles for the potential operators/users may include one or more of a historical component, a performance component, and/or a dynamic component. The historical component may include historic selections of a user. The user profile component 221 may record how often the user selects to retain control of each driving operation over time. The user profile component 221 may determine, for future trips, whether each of the driving operations are more often or not (or more often than a certain threshold) performed by the user. The user profile component 221 may compare the historical component of the user profile to determine whether certain operations are recommended to be performed by the user.

The performance component may include a rating of how well the user has performed with specific driving operations in the past. For example, the user profile component 221 may record the operations performed by the user. The user profile component 221 may compare operations performed by manual operations to what would have been performed by computer operation. For example, the sensors of the vehicle may detect obstacles and the driving module 215 calculate steering corrections in response to those detections even those the user is performing steering. The user profile component 221 may compare the steering adjustment that would have been made by the driving module 215 to the steering adjustment performed by the user. The user profile component 221 may compare the time delay before the steering adjustment is made to the time delay that would have been required by the driving module 215. The user profile component 221 may rate the difference determined by one or more of these types of comparison as the performance component of the user profile. The user profile component 221 may compare the performance component of the user profile to determine whether certain operations are recommended to be performed by the specific user.

The dynamic component may include one or more other individual factors of the user. The dynamic component may indicate whether the user has been awake for a certain amount of time. The dynamic component may indicate whether the user has visited certain risky locations (e.g., a bar where alcohol is served). The dynamic component may indicate whether the user's calendar indicates any distractions such as phone calls or meetings. The user profile component 221 may rate these types of indicators to a value for the dynamic component of the user profile. The user profile component 221 may compare the dynamic component of the user profile to determine whether certain operations are recommended to be performed by the user.

The vehicle component 225 may include any one or a combination of a historical component, a performance component, and/or an organizational component. The historical component of the vehicle component may include a value derived from past selections made for a specific vehicle or mobile device. The vehicle component 225 may record how often particular selections for control have been made for the vehicle or mobile device over time. The vehicle component 225 may determine, for future trips, whether each of the driving operations are more often or not (or more often than a certain threshold) performed by a specific user. The vehicle component 225 may compare the historical component of the vehicle component to determine whether certain operations are recommended to be performed by which user, automatically by the vehicle, or remotely by another operator.

The performance component of the vehicle component 225 may include a rating of how well the vehicle systems have performed with specific driving operations in the past. For example, the vehicle component 225 may record the operations performed by the driving module 215. The vehicle component 225 may log when the driving module 215 has failed or required assistance. The vehicle component 225 may log when the driving module 215 has identified an error or malfunction with a driving operation. The vehicle component 225 may calculate the performance component of the vehicle component based on one or more of these logs. The vehicle component 225 may compare the performance component of the user profile to determine whether certain operations are recommended to be performed by the user, by another user, by the driving module 215, or by a remote operator.

The organizational component of the vehicle component 225 may include one or more data values that indicate pre-selected recommendation for an organization. The organization may be a manufacturer of the vehicle. The manufacturer may indicate certain driving operations that are recommended to be performed by operators with certain skills or abilities. For example, the manufacturer may recommend that occupants have a minimum number of hours performing one or more operations prior to being recommended. The organization may be a fleet enterprise (e.g., shipping delivery network of vehicles, taxi service network of vehicles). Through policies or settings specified by the fleet enterprise, certain driving operations may be required or preferred to be performed by specific users, the driving module 215 and vehicle systems, or remote operators.

The organizational component of the vehicle component 225 may include one or more data values that indicate rules or regulations by a municipality or other government. For example, certain governments may only allow fully autonomous control or certain types of roads and/or restrict certain driving operations to specific areas. The vehicle component 225 may receive regulation data from an external service (e.g., regulation server) in response to the location of the vehicle or an upcoming calculated route. The vehicle component 225 may compare the regulations of the vehicle component to determine whether certain operations are recommended to be performed by certain users, automatically by the vehicle, or by a remote operator.

The government rules may also dictate where the SMMV 124 can drive. To be allowed in a lane on the road designated for autonomous driving, a threshold of operations should be performed by the driving module 215. For example, the simultaneous mix mode controller 126 may select a route according to the number of driving operations, or which operators are recommended. The simultaneous mix mode controller 126 may select a route that includes a road segment or lane of a road segment designated for autonomous control when the number of driving operations assigned for computer control exceeds a threshold. Similarly, the simultaneous mix mode controller 126 may recommend a route based on who is controls a certain operation based on the experience of the route by a specific operator. The threshold could be a percentage (e.g., 80% of the driving operations must be performed by an operator in order to select the preferred route). For another example, it could be based on core features where the braking and steering is controlled by the driving module 215. In another example, the mixed mode vehicles may be designated to a separate lane or route because of a potential for driving inconsistencies.

The environmental component 223 may be configured to identify road conditions such as traffic flow, speed, construction, and, for example, weather conditions. The environmental component 223 may include values that are weights applied to one or more driving operations in certain weather conditions. For example, braking may better be applied by a certain operator during rain or other precipitation. The environmental component 223 may compare the weather component of the vehicle component to a weather condition to determine whether certain operations are recommended to be performed by specific occupants. The weather conditions may be sensed by the vehicle. Direct sensing for the weather condition may include a rain sensor or a camera that collects images that are analyzed to determine the weather. Indirect sensing for the weather condition may infer the weather condition based on a windshield wiper setting or a headlight sensor.

The environmental component 223 may be accessed according to position data and/or map data from the geographic database 123. The simultaneous mix mode controller 126 may send a request to a weather service (e.g., weather server) based on the position data detected by the device 122. The simultaneous mix mode controller 126 may first determine a current road segment or upcoming road segment from the geographic database 123. The simultaneous mix mode controller 126 may send a request to the weather service based on the road segment. The weather service returns the current or upcoming weather condition.

The recommendation module 213 receives the analysis of the factor data 201 and provides a recommendation for the driving trip based on the factor data 201. That is, the one or more characteristics of the users and/or entities involved with the driving trip may impact whether a particular driving operation is recommended for a particular operator. In some instances, the operator's characteristic in the factor data 201 may indicate that the operator is skilled at braking (e.g., the operator has a low reaction time and high eye-hand coordination), which causes the recommendation to recommend the operation for braking be assigned to the specific operator. In some instances, the vehicle's characteristic may include a particular quantity or type of sensors, that causes the recommendation to include computer operation for braking. For example, when the vehicle includes proximity sensors, the recommendation module 213 may recommend that the vehicle perform braking. In some instances, the operator's characteristic in the factor data 201 may indicate that an operator prefers to drive at a speed different than the posted speed limits, which causes the recommendation to recommend the specific operator for acceleration. In some instance, the factor data 201 may indicate that the vehicle is configured to follow the posted speed limits or a percentage thereof, which causes the recommendation to include computer operation for acceleration. It may be a requirement of an insurance policy on the vehicle, an employment agreement of the driver of the vehicle, or a lease/sale of the vehicle that the computer operation be used for acceleration, or another specified driving operation. Various characteristics in the factor data 201 may impact the recommendation for various driving operations. In another example, a remote operator may be recommended when the SMMV 124 enters a challenging area or an occupant becomes impaired or distracted. In another example, a remote operator may not be recommended due to latency in a connection.

The recommendation module 213 may determine a list of driving operations for the driving trip. The list of possible driving operations may be a predetermined list or the list may be determined according to the trip. The predetermined list of driving operations may be specific to the vehicle or the occupants of the vehicle. The predetermined list of driving operations may be those driving operations that could be performed by each occupant, a computer, or a remote operator depending on the trip. For example, certain types of roads may not be suitable for autonomous driving. Urban, congested, or other types of driving may not be included in certain locations. Similarly, certain road geometries may not be suitable for autonomous driving. For example, certain curvatures, tunnels, may not be accurately traversed using fully autonomous driving. Certain segments may not be appropriate for remote operation due to latency or connection concerns. Certain operations may not be assigned to certain occupants due to visibility issues (for example, steering from the back seat when in a crowded urban area).

In one example, the factor data 201 may include compatibility data or corresponding profile for the first driving operation and the second driving operation. The compatibility data may define certain driving operations that are recommended together in groups. For example, the left turn signal and right turn signal may be grouped together so that both driving operations are controlled by a specific operator. As another example, acceleration and braking may be grouped together so that both driving operations are either manual controlled, computer controlled, or remotely controlled by a specific operator. The recommendation module 213 may determine a list of driving operations for the driving trip based on the compatibility data.

The simultaneous mix mode controller 126 may interact with one or more operators using the mixed mode interface 231. The mixed mode interface 231 may be included in a mobile device such as a phone or a device integrated with the vehicle. The mixed mode interface 231 allows a user to select one or more driving operations from a list of recommended control. The simultaneous mix mode controller 126 may send the list to a mobile device with one or more selectable indicators for the one or more driving operations.

The recommendations defined by the recommendation module 213 may be presented with the list. For example, the recommendation may be a pre-filled selection on the one or more selectable indicators. The user may provide input to the mixed mode interface 231 to either accept or modify the recommendations presented by the simultaneous mix mode driving controller 126. For example, when the recommendation includes a recommendation for a certain operator for braking and computer operation for steering, one or more of the users may de-select either setting. A user may switch operations to another occupant's control or switch both operations to computer control, for example.

The driving module 215 receives the selections provided to the mixed mode interface 231 and implements the operations as modified or approved by the users. The driving module 215 may generate commands for the vehicle (e.g., steering commands, braking commands) according to the operations assigned to computer operation. The driving module 215 may provide access to certain operations for remote operators. The driving module 215 may also provide indicators to the user for manual operation. For example, the driving module 215 may activate manual control in response to confirmations made outside of the mixed mode interface 231 (e.g., audible commands, mechanical switches on the vehicle).

In addition to the mixed mode interface 231, the vehicle may provide recommendations or reminders to the users through one or more indicators or lights (e.g., green lights) on or near the instruments or controls of the vehicle. For example, a light may be placed to illuminate the steering wheel, the brake, the accelerator, or others. The lights may communicate the recommendation to the users. That is, the recommendations on the mixed mode interface 231 may be paired with lights illuminating the corresponding devices in the vehicle. The lights may communicate reminders to the users. That is, after the selections for mixed mode operation have been made by the users, the lights may illuminate the devices in the vehicle corresponding to the one or more driving operations assigned to each user. In one example, the devices for driving operations selected a specific user are illuminated with a first color (e.g., green) and the devices for driving operations selected for a second user are illuminated with a second color (e.g., red).

The simultaneous mix mode controller 126 may be configured to adjust reaction times according to the recommendation for the driving operations or selections of the driving operation. In order for the operators to cooperate, one or more reaction times may be adjusted. For the simultaneous mix mode vehicles to drive normally, the reaction time of the human operators and the reaction time of vehicle should be aligned. Consider an example where the steering operation is performed by a first user and the braking operation is performed by a second user. When an obstacle is detected, and both the users should react, it could be problematic if the steering operation is performed immediately (e.g., in a few milliseconds) and the braking operation is not performed for a longer period of time (e.g., hundreds of milliseconds to 1 or 2 seconds). In this situation, a skid could result. The reaction time of the users are ascertained by allowing the users to manually enter the reaction time, determined from an online driving profile of the operators, or determined automatically via a series of action/reaction evaluations onboard the vehicle when the operators board the vehicle. The simultaneous mix mode controller 126 may also determine and confirm that the agreed reaction times are below the legal threshold.

The recommendation module 213 may update the factor data 201 based on user inputs received at the mixed mode interface 231. For example, the recommendation module 213 may recommend a set of operations for a user to perform based on historical selections. The user may override the recommended operations and the recommendation module 213 would self-learn and use this information to make better or different recommendations the next time. That is, the recommendation module 213 may receiver user inputs that override a recommendation and store those user inputs as user inputs. Alternatively, the recommendation module 213 may update the factor data 201 in light of the user inputs that override the recommendation.

In an example, the recommendation module 213 recommends that one occupant controls steering, acceleration, and the left turn signal, while another occupant controls the braking, horn, and right turn signal. The first occupant may override and unselect the left turn signal. Thus, the user agrees to perform only two operations, which are steering and acceleration. The second occupant then may operate the brake, horn, left and right turn signal. The recommendation module 213 modifies the factor data 201 to indicate that the first occupant prefers to not to operate the left turn signal or prefers only to operate steering and acceleration.

In an embodiment, the recommendation module 213 recommends specific controls to a specific people depending on a combination of multiple factors described below.

One factor may be the seating position or location of each respective occupant. In an example, the recommendation of the controlled operations may be based on the person's seat position. For example, person sitting on the right of the SMMV 124 may be assigned control of the right turn signal. As with all the factors, each individual factor may not be definitive. In this example, the seating position may favor a particular assignment, but other factors may favor other assignments. The combination of factors is used to determine the recommendations, not just a single factor.

Another factor is historical data for controlled operations. The recommendation of the controlled operations may be based on historically controlled operations by the human. For example, if there are two humans in the car and one has an history of operating a specific vehicle control successfully in the past, then the system may recommend this person to handle such operations. The historically operated controls may be saved to an operator's profile and may be used in multiple different vehicles. The profile may be accessed and updated in real time from within the SMMV 124.

Another factor is reaction times. The recommendation of the controlled operations may be based on reaction times of each occupant. Critical operations such as braking, and steering may be recommended to occupants with the fastest reaction times.

Another factor is the context of each occupant. The recommendation of the controlled operations may be based on a status or condition of an occupant. For example, the mood, a level of tiredness/drowsiness, availability, success rates with some controls, weather, demographics, etc. may be used as a factor.

Another factor is a location of the SMMV 124. The recommendation of the controlled operations may be based on geofencing, based on a dynamic risk attribute, HHW, population density, specific functional class roads, etc. As an example, different recommendations may be made for different types of roads, e.g., freeways or rural lanes.

Another factor is the expertise or experience of an operator. Occupants may have specialties such as being very experienced at braking. In this case braking operations may be recommended to the expert braker.

Another factor is driving efficiency. For example, the fuel efficiency during operations may be considered, in case one operator is usually better at fuel efficiency through more efficient braking, for example in a mountainous or urban area.

Another factor is a familiarity with an area based on historical information about an operator. The more familiar an operator is with an area, the more the operator may be recommended for taking over certain actions in the area.

All the above factors may be input into a recommender system algorithm such as collaborative filtering. The algorithm takes all the above factors into consideration and makes an automatic control recommendation. The recommender system is configured to filter information (the factor data) and provide a recommendation based on, for example, popularity, efficiency, or safety. Different recommender systems may be used such as content-based recommendation and collaborative filtering. For a content-based recommendation the recommender system analyzes the nature of each driving feature and, using the factors, determines which operator to match with each feature. For collaborative filtering, the recommender system recommends vehicle control based on the operator's profile, for example, the operator's history with operating each of the features. The recommender system provides recommendations for the operation of the SMMV 124 by learning each operator's abilities, interests, and preferences through interaction with each specific operator. The recommender system makes a prediction based on an operator's past actions, taking into account environmental and vehicle factor data.

Alternative recommendation systems may be used, for example, based on machine learning techniques. The recommender system may learn by inputting combinations of factor data into a network and comparing the output against labeled data, for example derived from feedback mechanisms. Different neural network configurations and workflows may be used for the network such as a convolution neural network (CNN), deep belief nets (DBN), or other deep networks. CNN learns feed-forward mapping functions while DBN learns a generative model of data. In addition, CNN uses shared weights for all local regions while DBN is a fully connected network (e.g., including different weights for all regions of an image). The training of CNN is entirely discriminative through backpropagation. DBN, on the other hand, employs the layer-wise unsupervised training (e.g., pre-training) followed by the discriminative refinement with backpropagation if necessary. In an embodiment, the arrangement of the trained network is a fully convolutional network (FCN). Alternative network arrangements may be used, for example, a 3D Very Deep Convolutional Networks (3D-VGGNet). VGGNet stacks many layer blocks containing narrow convolutional layers followed by max pooling layers. A 3D Deep Residual Networks (3D-ResNet) architecture may be used. A Resnet uses residual blocks and skip connections to learn residual mapping.

The neural network may be defined as a plurality of sequential feature units or layers. Sequential is used to indicate the general flow of output feature values from one layer to input to a next layer. Sequential is used to indicate the general flow of output feature values from one layer to input to a next layer. The information from the next layer is fed to a next layer, and so on until the final output. The layers may only feed forward or may be bi-directional, including some feedback to a previous layer. The nodes of each layer or unit may connect with all or only a sub-set of nodes of a previous and/or subsequent layer or unit. Skip connections may be used, such as a layer outputting to the sequentially next layer as well as other layers. Rather than pre-programming the features and trying to relate the features to attributes, the deep architecture is defined to learn the features at different levels of abstraction based on the input data. The features are learned to reconstruct lower-level features (i.e., features at a more abstract or compressed level). Each node of the unit represents a feature. Different units are provided for learning different features. Various units or layers may be used, such as convolutional, pooling (e.g., max pooling), deconvolutional, fully connected, or other types of layers. Within a unit or layer, any number of nodes is provided. For example, 100 nodes are provided. Later or subsequent units may have more, fewer, or the same number of nodes.

In another example of the application of a mixed mode recommendation for multiple occupants of the SMMV 124, the recommendation module 213 may analyze factor data for multiple users to determine which user is recommended for each driving operation recommended for manual operation, which driving operations are recommended for remote operation, and which driving operations are recommended for automated control. Some users may be more skilled at certain operations than others. Some users may prefer to perform some driving operations. The driving operations may be applied according to seat in the vehicle. Steering or braking may be better performed by a passenger in the front see where visibility is higher. Turn signals may be better operated by users in the back seats where blind spots can be avoided. For example, the user profiles include properties for multiple users. The profile may include a property of a primary user (e.g., driver seat passenger) and a property of a secondary user (e.g., any other passenger). The recommendation module 213 assigns one or more driving operations to the primary user and one or more driving operations to the secondary user based on the user profile and other factor data. The inputs for the recommendation module 213 are the factor data for multiple potential operators of a SMMV 124. The multiple potential operators may include two or more occupants of the SMMV 124, remote operators, and/or automated systems. The driving operations may be recommended/assigned to specific occupants according to a single factor or multiple factors. One factor may be schedule or calendar. The braking or steering operations may be switched from one user to another as their schedules permit them to provide attention to the driving operation. Another factor may be age. Non-critical operations such as turn signals or sunroof control may be assigned to children. Critical operations such as steering or braking may be assigned to primary passengers such as adults. The output of the recommendation module 213 is a set of recommendations for which operator should (or can) operate individual features of the SMMV 124 including, for example, a remote operator that operates the steering.

A remote operator may be an operator that is not located in the vehicle. The remote operator may be human or automated. In an example, the remote operator may provide human control of the SMMV 124 when an occupant is overwhelmed. Alternatively, a remote operator may not be able to control the SMMV 124 when sensors fail or road conditions become unwieldy, for example during inclement weather. The remote operator may have access to external sensors in addition to the vehicle's ones. The remote operator and the SMMV 124 may include an encrypted reliable wireless channel between them. Remote controlling must consider latency that depends on network connectivity thus it needs to consider the network coverage on the route. If the system detects that no fallback is possible for a given area because a critical sensor on the SMMV 124 is not working properly, or remote operations cannot be guaranteed due to high latency, and an occupant is unable to take over then the system may find a suitable location where to park the SMMV 124 and possibly trigger a request for a replacement vehicle (or whatever action might be suitable, e.g. reaching emergency services, calling the parents of a child who was alone in the AV, etc.).

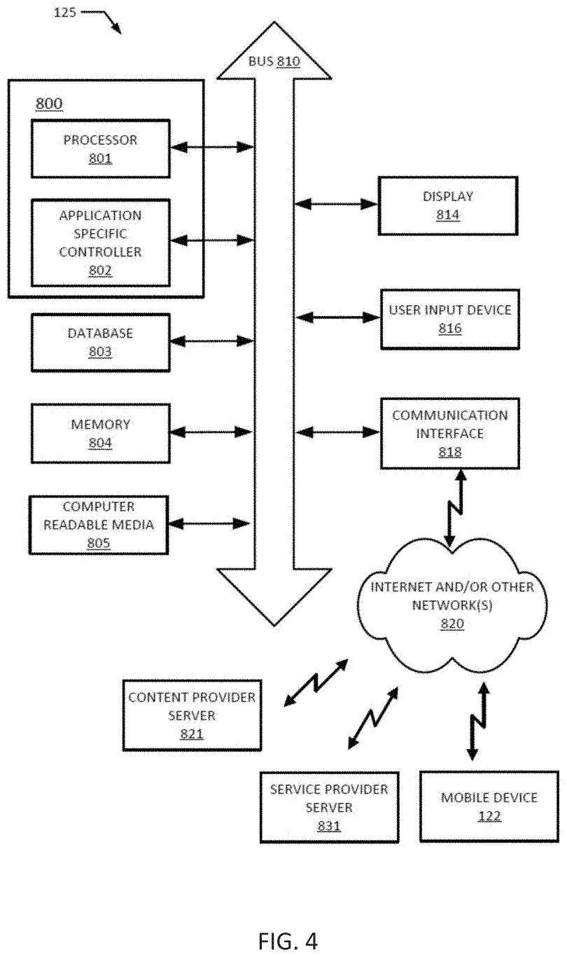

FIG. 4 illustrates an example server 125 for the system of FIG. 1. The server 125 may include a bus 810 that facilitates communication between a controller (e.g., the mixed mode driving controller 126) that may be implemented by a processor 801 and/or an application specific controller 802, which may be referred to individually or collectively as controller 800, and one or more other components including a database 803, a memory 804, a computer readable medium 805, a display 814, a user input device 816, and a communication interface 818 connected to the internet and/or other networks 820. The contents of database 803 are described with respect to database 123. The server-side database 803 may be a master database that provides data in portions to the database of the mobile device 122. Additional, different, or fewer components may be included.

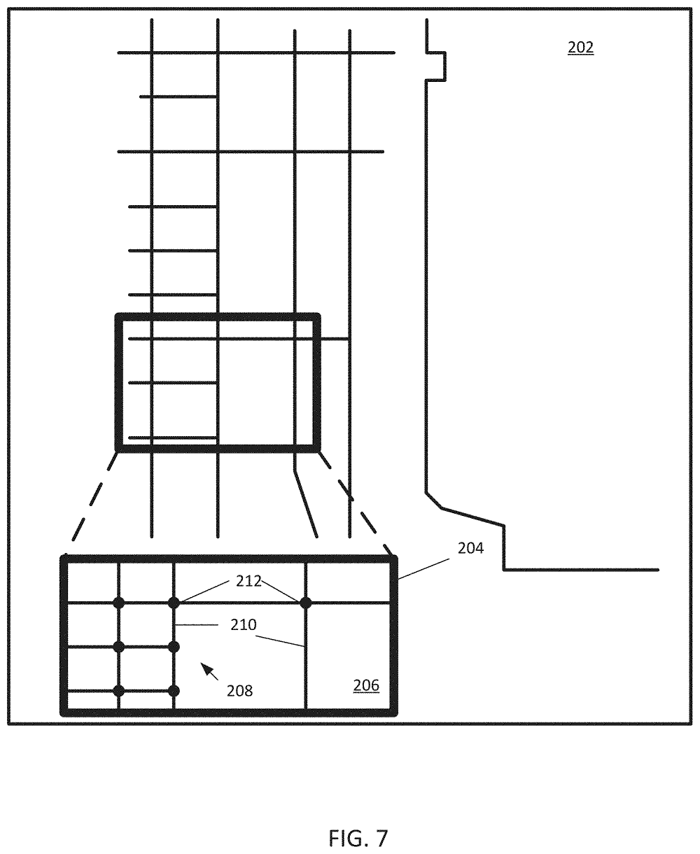

The memory 804 and/or the computer readable medium 805 may include a set of instructions that can be executed to cause the server 125 to perform any one or more of the methods or computer-based functions disclosed herein. In a networked deployment, the system of FIG. 7 may alternatively operate or as a client user computer in a client-server user network environment, or as a peer computer system in a peer-to-peer (or distributed) network environment. It can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. While a single computer system is illustrated, the term “system” shall also be taken to include any collection of systems or sub-systems that individually or jointly execute a set, or multiple sets, of instructions to perform one or more computer functions.

The server 125 may be in communication through the network 820 with a content provider server 821 and/or a service provider server 831. The server 125 may provide the point cloud to the content provider server 821 and/or the service provider server 831. The content provider may include device manufacturers that provide location-based services associated with different locations POIs that users may access.

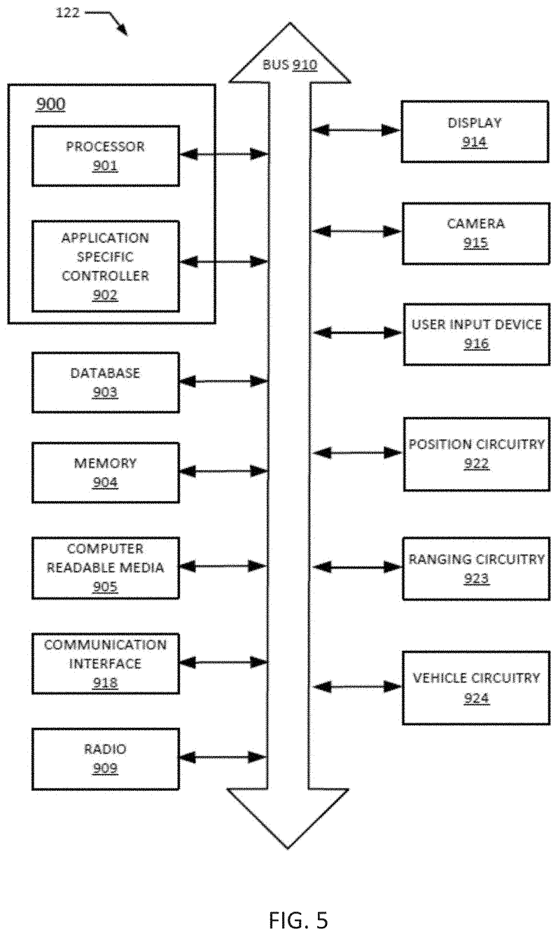

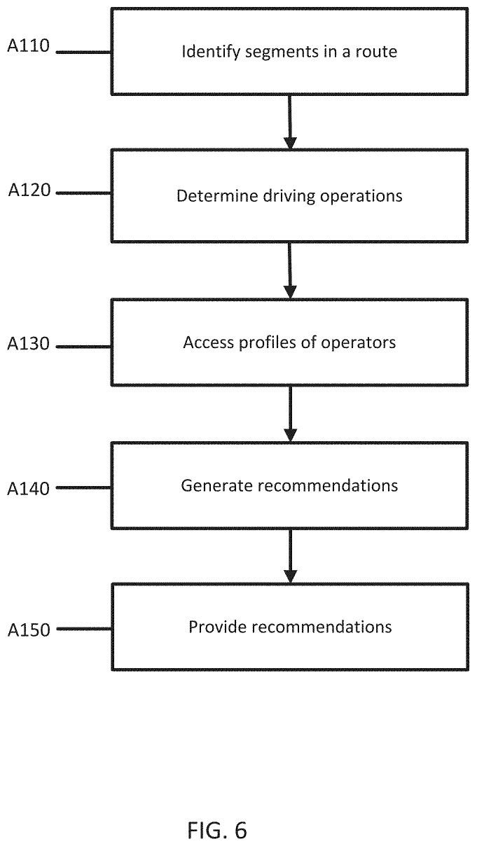

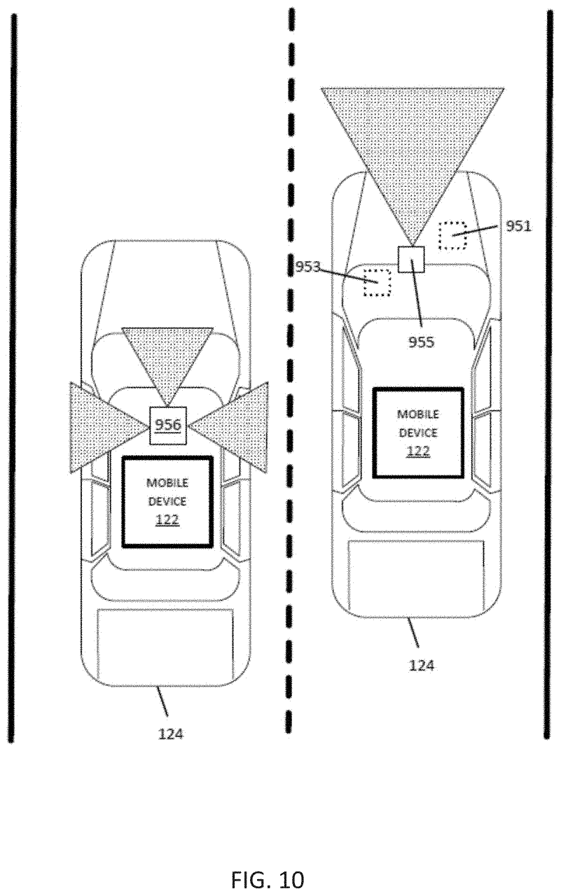

FIG. 5 illustrates an example mobile device 122 for the system of FIG. 1. The mobile device 122 may include a bus 910 that facilitates communication between a controller (e.g., the simultaneous mix mode driving controller 126) that may be implemented by a processor 901 and/or an application specific controller 902, which may be referred to individually or collectively as controller 900, and one or more other components including a database 903, a memory 904, a computer readable medium 905, a communication interface 918, a radio 909, a display 914, a camera 915, a user input device 916, position circuitry 922, ranging circuitry 923, and vehicle circuitry 924. The contents of the database 903 are described with respect to database 123. The device-side database 903 may be a user database that receives data in portions from the database 903 of the mobile device 122. The communication interface 918 connected to the internet and/or other networks (e.g., network 820 shown in FIG. 6). The vehicle circuitry 924 may include any of the circuitry and/or devices described with respect to FIG. 10. Additional, different, or fewer components may be included.

FIG. 6 illustrates an example flow chart for simultaneous mix mode driving performed by the mobile device of FIG. 5. Additional, different, or fewer acts may be included.

At act A110, the device identifies a plurality of segments for a route for a vehicle to traverse from a starting point to a destination. The controller 800 or 900 may include a routing module including an application specific module or processor that calculates routing between an origin and destination. The routing module is an example means for generating a route in response to the anonymized data to the destination. The routing command may be a driving instruction (e.g., turn left, go straight), which may be presented to a driver or passenger, or sent to an assisted driving system. The display 914 is an example means for displaying the routing command. The mobile device 122 may generate a routing instruction based on the anonymized data.

The routing instructions may be provided by display 914. The mobile device 122 may be configured to execute routing algorithms to determine an optimum route to travel along a road network from an origin location to a destination location in a geographic region. Using input(s) including map matching values from the server 125, a mobile device 122 examines potential routes between the origin location and the destination location to determine the optimum route. The mobile device 122, which may be referred to as a navigation device, may then provide the end user with information about the optimum route in the form of guidance that identifies the maneuvers required to be taken by the end user to travel from the origin to the destination location. Some mobile devices 122 show detailed maps on displays outlining the route, the types of maneuvers to be taken at various locations along the route, locations of certain types of features, and so on. Possible routes may be calculated based on a Dijkstra method, an A-star algorithm or search, and/or other route exploration or calculation algorithms that may be modified to take into consideration assigned cost values of the underlying road segments.

The mobile device 122 may plan a route through a road system or modify a current route through a road system in response to the request for additional observations of the road object. For example, when the mobile device 122 determines that there are two or more alternatives for the optimum route and one of the routes passes the initial observation point, the mobile device 122 selects the alternative that passes the initial observation point. The mobile devices 122 may compare the optimal route to the closest route that passes the initial observation point. In response, the mobile device 122 may modify the optimal route to pass the initial observation point.

The mobile device 122 may be a personal navigation device (“PND”), a portable navigation device, a mobile phone, a personal digital assistant (“PDA”), a watch, a tablet computer, a notebook computer, and/or any other known or later developed mobile device or personal computer. The mobile device 122 may also be an automobile head unit, infotainment system, and/or any other known or later developed automotive navigation system. Non-limiting embodiments of navigation devices may also include relational database service devices, mobile phone devices, car navigation devices, and navigation devices used for air or water travel.

The geographic database 123 may include map data representing a road network or system including road segment data and node data. The road segment data represent roads, and the node data represent the ends or intersections of the roads. The road segment data and the node data indicate the location of the roads and intersections as well as various attributes of the roads and intersections. Other formats than road segments and nodes may be used for the map data. The map data may include structured cartographic data or pedestrian routes. The map data may include map features that describe the attributes of the roads and intersections. The map features may include geometric features, restrictions for traveling the roads or intersections, roadway features, or other characteristics of the map that affects how vehicles 124 or mobile device 122 for through a geographic area. The geometric features may include curvature, slope, or other features. The curvature of a road segment describes a radius of a circle that in part would have the same path as the road segment. The slope of a road segment describes the difference between the starting elevation and ending elevation of the road segment. The slope of the road segment may be described as the rise over the run or as an angle. The geographic database 123 may also include other attributes of or about the roads such as, for example, geographic coordinates, street names, address ranges, speed limits, turn restrictions at intersections, and/or other navigation related attributes (e.g., one or more of the road segments is part of a highway or toll way, the location of stop signs and/or stoplights along the road segments), as well as points of interest (POIs), such as gasoline stations, hotels, restaurants, museums, stadiums, offices, automobile dealerships, auto repair shops, buildings, stores, parks, etc. The databases may also contain one or more node data record(s) which may be associated with attributes (e.g., about the intersections) such as, for example, geographic coordinates, street names, address ranges, speed limits, turn restrictions at intersections, and other navigation related attributes, as well as POIs such as, for example, gasoline stations, hotels, restaurants, museums, stadiums, offices, automobile dealerships, auto repair shops, buildings, stores, parks, etc. The geographic data may additionally or alternatively include other data records such as, for example, POI data records, topographical data records, cartographic data records, routing data, and maneuver data.

FIG. 7 illustrates a map of a geographic region 202. The geographic region 202 may correspond to a metropolitan or rural area, a state, a country, or combinations thereof, or any other area. Located in the geographic region 202 are physical geographic features, such as roads, points of interest (including businesses, municipal facilities, etc.), lakes, rivers, railroads, municipalities, etc. FIG. 7 further depicts an enlarged map 204 of a portion 206 of the geographic region 202. The enlarged map 204 illustrates part of a road network 208 in the geographic region 202. The road network 208 includes, among other things, roads and intersections located in the geographic region 202. As shown in the portion 206, each road in the geographic region 202 is composed of one or more road segments 210. A road segment 210 represents a portion of the road. Road segments 210 may also be referred to as links. Each road segment 210 is shown to have associated with it one or more nodes 212; one node represents the point at one end of the road segment and the other node represents the point at the other end of the road segment. The node 212 at either end of a road segment 210 may correspond to a location at which the road meets another road, i.e., an intersection, or where the road dead ends.

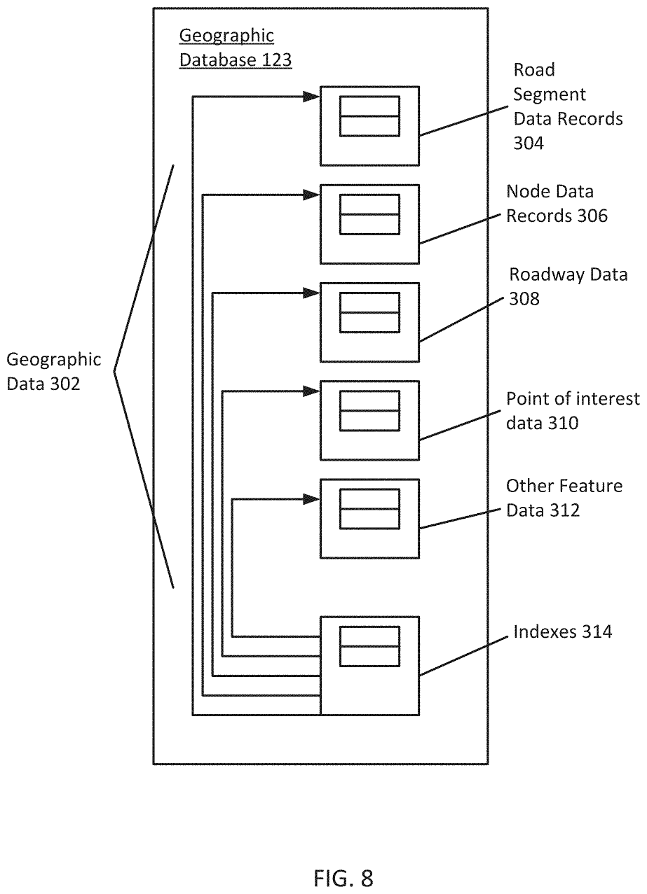

As depicted in FIG. 8, in one embodiment, the geographic database 123 contains geographic data 302 that represents some of the geographic features in the geographic region 202 depicted in FIG. 3. The data 302 contained in the geographic database 123 may include data that represent the road network 208. In FIG. 4, the geographic database 123 that represents the geographic region 202 may contain at least one road segment database record 304 (also referred to as “entity” or “entry”) for each road segment 210 in the geographic region 202. The geographic database 123 that represents the geographic region 202 may also include a node database record 306 (or “entity” or “entry”) for each node 212 in the geographic region 202. The terms “nodes” and “segments” represent only one terminology for describing these physical geographic features, and other terminology for describing these features is intended to be encompassed within the scope of these concepts.

The geographic database 123 may include feature data 308-312. The feature data 312 may represent types of geographic features. For example, the feature data may include roadway data 308 including signage data, lane data, traffic signal data, physical and painted features like dividers, lane divider markings, road edges, center of intersection, stop bars, overpasses, overhead bridges, etc. The roadway data 308 may be further stored in sub-indices that account for different types of roads or features. The point of interest data 310 may include data or sub-indices or layers for different types of points of interest. The point of interest data may include point of interest records comprising a type (e.g., the type of point of interest, such as restaurant, fuel station, hotel, city hall, police station, historical marker, ATM, golf course, truck stop, vehicle chain-up stations, etc.), location of the point of interest, a phone number, hours of operation, etc. The feature data 312 may include other roadway features.

The geographic database 123 also includes indexes 314. The indexes 314 may include various types of indexes that relate the different types of data to each other or that relate to other aspects of the data contained in the geographic database 123. For example, the indexes 314 may relate the nodes in the node data records 306 with the end points of a road segment in the road segment data records 304.

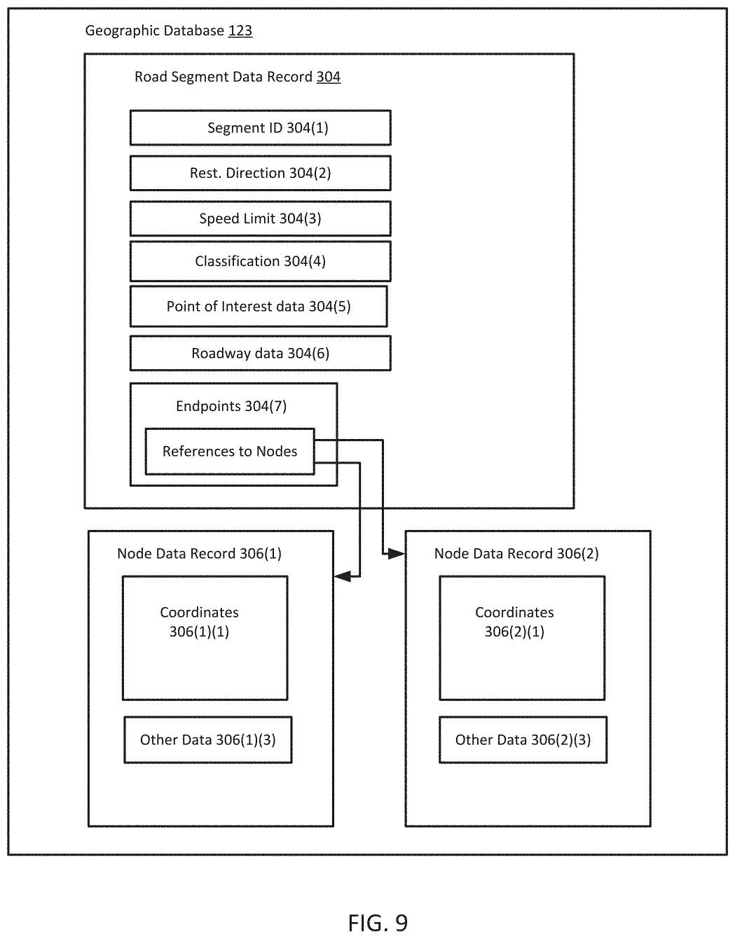

FIG. 9 shows some of the components of a road segment data record 304 contained in the geographic database 123 according to one embodiment. The road segment data record 304 may include a segment ID 304(1) by which the data record can be identified in the geographic database 123. Each road segment data record 304 may have associated information such as “attributes”, “fields”, etc. that describes features of the represented road segment. The road segment data record 304 may include data 304(2) that indicate the restrictions, if any, on the direction of vehicular travel permitted on the represented road segment. The road segment data record 304 may include data 304(3) that indicate a speed limit or speed category (i.e., the maximum permitted vehicular speed of travel) on the represented road segment. The road segment data record 304 may also include classification data 304(4) indicating whether the represented road segment is part of a controlled access road (such as an expressway), a ramp to a controlled access road, a bridge, a tunnel, a toll road, a ferry, and so on. The road segment data record 304 may include data 304(5) related to points of interest. The road segment data record 304 may include data 304(6) that describes lane configurations. The road segment data record 304 also includes data 304(7) providing the geographic coordinates (e.g., the latitude and longitude) of the end points of the represented road segment. In one embodiment, the data 304(7) are references to the node data records 306 that represent the nodes corresponding to the end points of the represented road segment. The road segment data record 304 may also include or be associated with other data 304(7) that refer to various other attributes of the represented road segment such as coordinate data for shape points, POIs, signage, other parts of the road segment, etc. The various attributes associated with a road segment may be included in a single road segment record, or may be included in more than one type of record which cross-references each other. For example, the road segment data record 304 may include data identifying what turn restrictions exist at each of the nodes which correspond to intersections at the ends of the road portion represented by the road segment, the name or names by which the represented road segment is known, the street address ranges along the represented road segment, and so on.

FIG. 9 also shows some of the components of a node data record 306 which may be contained in the geographic database 123. Each of the node data records 306 may have associated information (such as “attributes”, “fields”, etc.) that allows identification of the road segment(s) that connect to it and/or a geographic position (e.g., latitude and longitude coordinates). For the embodiment shown in FIG. 9, the node data records 306(1) and 306(2) include the latitude and longitude coordinates 306(1)(1) and 306(2)(1) for their node. The node data records 306(1) and 306(2) may also include other data 306(1)(3) and 306(2)(3) that refer to various other attributes of the nodes. The data in the geographic database 123 may be organized using a graph that specifies relationships between entities. A location graph is a graph that includes relationships between location objects in a variety of ways. Objects and their relationships may be described using a set of labels. Objects may be referred to as “nodes” of the location graph, where the nodes and relationships among nodes may have data attributes. The organization of the location graph may be defined by a data scheme that defines the structure of the data. The organization of the nodes and relationships may be stored in an ontology which defines a set of concepts where the focus is on the meaning and shared understanding. These descriptions permit mapping of concepts from one domain to another. The ontology is modeled in a formal knowledge representation language which supports inferencing and is readily available from both open-source and proprietary tools.

Referring back to FIG. 6, at act A120, determining a plurality of driving operations for each of the plurality of segments. The controller 900 receives a list of driving operations for the route. The default list of possible driving operations may be specific to the type of driver or type of vehicle. The default list may be configurable by an administrator.

At act A130, the device 122 accesses profiles for at least two or more operators that are capable of performing at least one driving operation of the plurality of driving operations. The controller 900 accesses profiles of the operators. As described herein various profiles are possible. The profile may be a user profile, a vehicle profile, an environmental profile, etc. The controller 900 may determine a user identity, such as entry in the user input device 916 or a connection and handshake with a device of the user. The controller 900 may access the profile from the memory 904 based on the user identity.

The profile may be a vehicle profile. The controller 900 may determine a vehicle identity, such as entry in the user input device 916 or a connection and handshake with the vehicle. The vehicle identity may be stored for example by the memory 904. The controller 900 may access the profile from the memory 904 based on the vehicle identity.

The profile may be a trip profile. The controller 900 may receive position information determined by the position circuitry 922 or the ranging circuitry 923. The controller 900 may calculate a route based on position data for the current location and a destination received from the user input device 916. The controller 900 may determine the trip profile based on the route from the current location to the destination.

The profile may be an environment profile such as a weather profile. The controller 900 may request weather information, for example, from service provider server 831. The controller 900 may determine the environment profile in response to the weather information.

In an embodiment, at least one operator is remotely located. In another embodiment, at least one operator is an automated driving system configured to perform at least of the actions.

At act A140, the device 122 generates recommendations for which operator to perform each of the plurality of driving operations for each of the plurality of segments based on at least the profiles of the at least two or more operators. The controller 900 determines at least one recommended driving operation included in the list of possible operations based on the profiles. The at least one recommended driving operation includes a first driving operation designated to a first operator and a second driving operation designated to a second operator.

At act A150, the device 122 provides the recommendations to the at least two or more occupants. The controller 900 and/or the display 914, which may be combined with the user input device 916, provides the recommended driving operation to the user.

FIG. 10 illustrates two SMMVs 124 associated with the system of FIG. 1 for providing mixed mode driving systems. The SMMVs 124 may include a variety of devices that collect position data as well as other related sensor data for the surroundings of the SMMV 124. The position data may be generated by a global positioning system, a dead reckoning-type system, cellular location system, or combinations of these or other systems, which may be referred to as position circuitry or a position detector. The positioning circuitry may include suitable sensing devices that measure the traveling distance, speed, direction, and so on, of the SMMV 124. The positioning system may also include a receiver and correlation chip to obtain a GPS or GNSS signal. Alternatively, or additionally, the one or more detectors or sensors may include an accelerometer built or embedded into or within the interior of the SMMV 124. The vehicle 124 may include one or more distance data detection device or sensor, such as a LIDAR device. The distance data detection sensor may generate point cloud data. The distance data detection sensor may include a laser range finder that rotates a mirror directing a laser to the surroundings or vicinity of the collection vehicle on a roadway or another collection device on any type of pathway. The distance data detection device may generate the trajectory data. Other types of pathways may be substituted for the roadway in any embodiment described herein.

A connected vehicle includes a communication device and an environment sensor array for reporting the surroundings of the vehicle 124 to the server 125. The connected vehicle may include an integrated communication device coupled with an in-dash navigation system. The connected vehicle may include an ad-hoc communication device such as a mobile device 122 or smartphone in communication with a vehicle system. The communication device connects the vehicle to a network including at least one other vehicle and at least one server. The network may be the Internet or connected to the internet.

The sensor array may include one or more sensors configured to detect surroundings of the vehicle 124. The sensor array may include multiple sensors. Example sensors include an optical distance system such as LiDAR 956, an image capture system 955 such as a camera, a sound distance system such as sound navigation and ranging (SONAR), a radio distancing system such as radio detection and ranging (RADAR) or another sensor. The camera may be a visible spectrum camera, an infrared camera, an ultraviolet camera, or another camera.

In some alternatives, additional sensors may be included in the vehicle 124. An engine sensor 951 may include a throttle sensor that measures a position of a throttle of the engine or a position of an accelerator pedal, a brake senor that measures a position of a braking mechanism or a brake pedal, or a speed sensor that measures a speed of the engine or a speed of the vehicle wheels. Another additional example, vehicle sensor 953, may include a steering wheel angle sensor, a speedometer sensor, or a tachometer sensor.

A mobile device 122 may be integrated in the vehicle 124, which may include assisted driving vehicles such as autonomous vehicles, highly assisted driving (HAD), and advanced driving assistance systems (ADAS). Any of these assisted driving systems may be incorporated into mobile device 122. Alternatively, an assisted driving device may be included in the vehicle 124. The assisted driving device may include memory, a processor, and systems to communicate with the mobile device 122. The assisted driving vehicles may respond to the driving commands from the driving module 215 and based on map data received from geographic database 123 and the server 125.

The assisted driving device may provide different levels of automation. In level 1, a driver and the automated system share control of the vehicle. Examples of level 1 include adaptive cruise control (ACC), where the driver controls steering and the automated system controls speed, and parking assistance, where steering is automated while speed is manual. Level 1 may be referred to as “hands off” because the driver should be prepared to retake full control of the vehicle at any time. Lane keeping assistance (LKA) Type II is a further example of level 1 driver assistance.

In level 2, the automated system takes full control of the vehicle (accelerating, braking, and steering). The driver monitors the driving and be prepared to intervene immediately at any time if the automated system fails to respond properly. Though level 2 driver assistance may be referred to as “hands off” because the automated system has full control of acceleration braking and steering, in some cases, contact between hand and steering wheel is often required to confirm that the driver is ready to intervene. In this way, the driver supervises the actions of the driver assistance features.

In level 3, the driver can safely turn their attention away from the driving tasks, e.g., the driver can text or watch a movie. Level 3 may be referred to as “eyes off.” The vehicle may handle situations that call for an immediate response, such as emergency braking. The driver should still be prepared to intervene within some limited period of time, often specified by the manufacturer, when called upon by the vehicle to do so. The car has a so-called “traffic jam pilot” that, when activated by a human driver, allows the car to take full control of all aspects of driving in slow-moving traffic at up to 60 kilometers per hour (37 miles per hour). However, the function works only on highways with a physical barrier separating one stream of traffic from oncoming traffic.

In level 4, similar automated control as in level 3, but no driver attention is required for safety. For example, the driver may safely go to sleep or leave the driver's seat. Level 4 may be referred to as “mind off” or “driverless.” Self-driving in level 4 may be supported only in limited spatial areas (e.g., within geofenced areas) or under special circumstances, like traffic jams. Outside of these areas or circumstances, the vehicle may safely abort the trip (e.g., park the car) if the driver does not retake control.

In level 5, no human intervention is required to drive the vehicle. As a result, a vehicle with level 5 driver assistance features may not require or have a steering wheel installed. An example would be a robotic taxi. Level 5 driver assistance may be referred to as “autonomous driving” because the vehicle may drive on a road without human intervention. In many cases, it is used as the same term as a driverless car, or a robotic car.

The controller 900 may communicate with a vehicle ECU which operates one or more driving mechanisms (e.g., accelerator, brakes, steering device). Alternatively, the mobile device 122 may be the vehicle ECU, which operates the one or more driving mechanisms directly.

The radio 909 may be configured to radio frequency communication (e.g., generate, transit, and receive radio signals) for any of the wireless networks described herein including cellular networks, the family of protocols known as WIFI or IEEE 802.11, the family of protocols known as Bluetooth, or another protocol.

The memory 804 and/or memory 904 may be a volatile memory or a non-volatile memory. The memory 804 and/or memory 904 may include one or more of a read only memory (ROM), random access memory (RAM), a flash memory, an electronic erasable program read only memory (EEPROM), or other type of memory. The memory 904 may be removable from the mobile device 122, such as a secure digital (SD) memory card.

The communication interface 818 and/or communication interface 918 may include any operable connection or transmitter. An operable connection may be one in which signals, physical communications, and/or logical communications may be sent and/or received. An operable connection may include a physical interface, an electrical interface, and/or a data interface. The communication interface 818 and/or communication interface 918 provides for wireless and/or wired communications in any now known or later developed format.

The input device 916 may be one or more buttons, keypad, keyboard, mouse, stylus pen, trackball, rocker switch, touch pad, voice recognition circuit, or other device or component for inputting data to the mobile device 122. The input device 916 and display 914 be combined as a touch screen, which may be capacitive or resistive. The display 914 may be a liquid crystal display (LCD) panel, light emitting diode (LED) screen, thin film transistor screen, or another type of display. The output interface of the display 914 may also include audio capabilities, or speakers. In an embodiment, the input device 916 may involve a device having velocity detecting abilities.

The ranging circuitry 923 may include a LIDAR system, a RADAR system, a structured light camera system, SONAR, or any device configured to detect the range or distance to objects from the mobile device 122.

The positioning circuitry 922 may include suitable sensing devices that measure the traveling distance, speed, direction, and so on, of the mobile device 122. The positioning system may also include a receiver and correlation chip to obtain a GPS signal. Alternatively, or additionally, the one or more detectors or sensors may include an accelerometer and/or a magnetic sensor built or embedded into or within the interior of the mobile device 122. The accelerometer is operable to detect, recognize, or measure the rate of change of translational and/or rotational movement of the mobile device 122. The magnetic sensor, or a compass, is configured to generate data indicative of a heading of the mobile device 122. Data from the accelerometer and the magnetic sensor may indicate orientation of the mobile device 122. The mobile device 122 receives location data from the positioning system. The location data indicates the location of the mobile device 122.

The positioning circuitry 922 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 922 may include suitable sensing devices that measure the traveling distance, speed, direction, and so on, of the mobile device 122. The positioning system may also include a receiver and correlation chip to obtain a GPS signal. The mobile device 122 receives location data from the positioning system. The location data indicates the location of the mobile device 122.

The position circuitry 922 may also include gyroscopes, accelerometers, magnetometers, or any other device for tracking or determining movement of a mobile device. The gyroscope is operable to detect, recognize, or measure the current orientation, or changes in orientation, of a mobile device. Gyroscope orientation change detection may operate as a measure of yaw, pitch, or roll of the mobile device.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network devices.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. In an embodiment, a vehicle may be considered a mobile device, or the mobile device may be integrated into a vehicle.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. These examples may be collectively referred to as a non-transitory computer readable medium.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A system for simultaneous mix mode driving, the system comprising:
a simultaneous mix mode controller for a simultaneous mix mode vehicle configured for two or more different operators to control a plurality of driving features;
a mapping system configured to store profile data for the two or more different operators;
a geographic database configured to store mapping data;
one or more sensors configured to acquire sensor data for the simultaneous mix mode vehicle.
wherein the simultaneous mix mode controller is configured to generate recommendations for which operator to control each of the driving features as a function of the profile data, mapping data, and sensor data, the simultaneous mix mode controller further configured to provide access to respective interfaces for the recommended operators to perform the recommended operations.

2. The system of claim 1, wherein at least two of the two or more different operators are occupants of the simultaneous mix mode vehicle.

3. The system of claim 1, wherein at least one of the two or more different operators is remotely located.

4. The system of claim 1, wherein at least one of the two or more different operators is an autonomous system configured to control at least one of the plurality of driving features.

5. The system of claim 1, wherein the plurality of driving features comprises at least steering, braking, acceleration, horn, left turn signal, and right turn signal for the simultaneous mix mode vehicle.

6. The system of claim 1, wherein the profile data for the two or more different operators comprises historical driving records for the two or more different operators.

7. The system of claim 1, wherein the profile data for the two or more different operators comprises data relating to fuel efficiency of the two or more different operators while operating one or more driving features of the plurality of driving features.

8. The system of claim 1, wherein the sensor data comprises data about locations of each respective operator, wherein the recommendations are based on the respective locations.

9. The system of claim 1, wherein the mapping data comprises data about roadway conditions, wherein the recommendations are based on the roadway conditions.

10. A method for mix mode driving, the method comprising:
identifying a plurality of segments for a route for a vehicle to traverse from a starting point to a destination;
determining a plurality of driving operations for each of the plurality of segments;
accessing profiles for at least two or more operators of the vehicle that are capable of performing at least one driving operation of the plurality of driving operations;
generating recommendations for which operator to perform each of the plurality of driving operations for each of the plurality of segments based on at least the profiles of the at least two or more operator; and
providing the recommendations to the at least two or more operators.

11. The method of claim 10, further comprising accessing a profile for at least one remote entity that is capable of performing at least one driving operation of the plurality of driving operations, wherein the recommendations include at least one recommendation for the at least one remote entity to perform at least one driving operation of the plurality of driving operations for at least one segment of the plurality of segments.

12. The method of claim 10, further comprising:
displaying the at least one driving recommendation on a mixed mode interface.

13. The method of claim 12, further comprising:
receiving a selection on the mixed mode interface.

14. The method of claim 10, wherein the recommendations are different for at least two different segments of the plurality of segments.

15. The method of claim 10, wherein the two or more operators are occupants of the vehicle.

16. The method of claim 10, wherein the profiles comprise historical data for controlled operations by each of the two of more operators.

17. The method of claim 10, wherein the profiles comprise reaction time data for controlled operations by each of the two of more operators, wherein one or more operations are recommended to operators with the fastest reaction times.

18. An apparatus for mixed mode driving, the apparatus comprising:
a memory configured to store profile data for at least two occupants of a simultaneous mix mode vehicle; and
a controller configured to determine at least one recommended driving operation included in a list of possible operations based on the profile data, the at least one recommended driving operation including a first driving operation designated to a first occupant and a second driving operation designated to a second occupant.

19. The apparatus of claim 18, further comprising:
at least two user interfaces configured to control a plurality of features of the simultaneous mix mode vehicle.

20. The apparatus of claim 18, further comprising:
a transmitter configured to communicate with a remote operator, wherein the at least one recommended driving operation includes a third driving operation designed to the remote operator.
